(19) United States
(12) Patent Application Publication
(10) Pub. No.: US 2021/0351478 A1
(43) Pub. Date: Nov. 11, 2021

(54) SEPARATOR FOR LITHIUM ION BATTERY AND METHOD FOR PREPARING THE SAME, AND LITHIUM ION BATTERY

(71) Applicant: SOUTH CHINA UNIVERSITY OF TECHNOLOGY, Guangzhou (CN)

(72) Inventors: HAIHUI WANG, Guangzhou (CN); JIAN XUE, Guangzhou (CN); SUQING WANG, Guangzhou (CN)

(21) Appl. No.: 17/381,214

(22) Filed: Jul. 21, 2021

Related U.S. Application Data
(63) Continuation of application No. PCT/CN2020/119856, filed on Oct. 7, 2020.

(30) Foreign Application Priority Data
Oct. 8, 2019 (CN) 201910951282.6

(51) Int. Cl. H01M 50/451; H01M 10/0525; H01M 50/403

(52) U.S. Cl. CPC H01M 50/451; H01M 50/403; H01M 10/0525

(57) ABSTRACT

A lithium ion battery diaphragm, comprising a substrate and a modification layer, wherein the modification layer is an inorganic coating; the inorganic coating is composed of a first particle layer and a second particle layer; the first particle layer has a first particle size r, and the second particle layer has a second particle size r′, wherein the particle sizes r and r′ satisfy the following relationship: (2\sqrt{3}/3−1)<(r′/r)<(\sqrt{6}/2−1); first particles are at least one or more of boehmite, aluminum oxide, titanium oxide, calcium oxide, zinc oxide, copper oxide, and manganese oxide; and second particles are natural organic particles, and are prepared from natural organic shells, wherein the natural organic shells are selected from eggshells and seashells. The first particle layer and the second particle layer are combined to form an integrated lithium battery diaphragm material.

### CROSS REFERENCE TO RELATED APPLICATION

This application is a continuation of International Application No. PCT/CN2020/119856, filed on Oct. 7, 2020. The International Application No. PCT/CN2020/119856 claims priority to a Chinese patent application No. 201910951282.6, filed on Oct. 8, 2019. The entirety of the above-mentioned applications is hereby incorporated by reference herein.

### TECHNICAL FIELD

This disclosure relates to a separator for a lithium ion battery, and more particularly, to a high-performance lithium ion battery separator modified with inorganic particles, the preparation method thereof, and a lithium ion battery.

### BACKGROUND

Lithium ion battery is mainly composed of positive/negative electrode materials, a electrolyte, a separator, and packaging materials for battery case. The separator is an important part of lithium ion battery, which is used to separate the positive and negative electrodes, prevent short circuit inside the battery, allow lithium ions to pass freely, and complete the electrochemical charging and discharging processes. The performance of the separator determines the interface structure and internal resistance of the battery, which directly affects the performance of the battery, such as rate capability, cycle performance, and safety (high temperature resistance). A separator with excellent performance plays an important role in improving the overall performance of the battery. The separator is called the third electrode of the battery in the industry.

At present, single-layer polyethylene (PE) separator, single-layer polypropylene (PP) separator, and PP/PE/PP tri-layer separator are widely used. Due to the thermoplasticity of polyolefin materials, when the temperature of the battery rises or the battery overheats locally, polyolefin materials will shrink and rupture, making the positive and negative electrodes of the battery directly contact, thereby causing a short circuit, which seriously affects the safety performance of the battery. For this reason, by coating ceramic particles on one or both sides of the polyolefin material, the shrinkage of the separator at high temperatures can be improved, thereby improving the high temperature resistance of the separator.

For example, as mentioned in J. Power Sources, 2017, 348: 80-86, PE separator modified by boehmite particles improves the thermal stability and electrochemical performance of the battery separator. However, the inorganic particles used are 350 nm, which makes it difficult to obtain a relatively thin coating. When coating the ceramic particles, ceramic particles should not be too small, otherwise, the pores on the surface of the porous separator will be blocked, thereby blocking the ion conduction channel, which will cause significant loss of battery capacity and cycle life.

For another example, CN 109860478 A discloses a preparation method of an organic-inorganic composite separator material, and an organic-inorganic composite separator material and application thereof, the plant cellulose is coated with Al2O3, the plant cellulose extracted from straws is taken as raw materials, a cellulose separator is prepared by employing a spin-coating method, and the prepared separator is coated with a layer of Al2O3 ceramic material. However, cellulose, as a plant fiber, has limited high temperature resistance, making it is difficult to meet the high-performance requirement of lithium ion battery, moreover, due to the large gap between alumina ceramic particles, it is difficult to obtain excellent separator performance.

For another example, CN 105161656 A discloses a polypropylene diaphragm for the lithium ion battery and a preparation method of the polypropylene diaphragm, the diaphragm is prepared from the following substances based on weight: 60-70 parts of polypropylene, 5-10 parts of vinyl acrylate, 5-10 parts of natural cellulose paste, 3-5 parts of keratin, 1-3 parts of ethylene glycol diglycidyl ether, 3-5 parts of brown algae extract, 1-3 parts of nano inorganic filler, 1-3 parts of mussel shell powder, 1-3 parts of halloysite nanotube and 3-5 parts of silane coupling agent. However, it uses a large number of organic modifiers, these modifiers will reduce the high temperature resistance of the diaphragm, and too much modifier will block the gap of the diaphragm.

For another example, CN 106025150 A discloses a battery separator prepared by using egg membranes. However, it is difficult to guarantee the quality of the separator. It is difficult to produce egg membranes in batch and large-scale, the manufacturing technique is difficult to be unified, and it is difficult to obtain products of uniform quality.

For another example, CN 109244318 A discloses: a preparation method of porous aragonite structure micron sheet, the porous aragonite structure micron sheet is separated from a natural shell body and further applied to a diaphragm. However, the diaphragm also requires more modifiers and binders. The use of more modifiers and binders reduces the reliability of the diaphragm, and too much binder reduces the pores of the diaphragm.

For another example, KR 20180007908 A discloses a separator for a lithium battery, which has a porous substrate and a porous coating layer. The separator is made of a fiber product composed of egg membranes and carbon fibers, it has a relatively large lithium ion transmission capacity, and it also has inorganic particles. However, the separator also uses a binder, and the binder polymer is fixed between the porous substrate and the inorganic particles, which reduces the high temperature resistance and may cause the membrane pores to be blocked.

### SUMMARY

In a first aspect, the disclosure provides a separator for a lithium ion battery. The separator includes a substrate and a modification layer, the substrate being a porous material selected from one or more of the group consisting of polyethylene, polypropylene, aramid, polyimide, polyethylene terephthalate, and cellulose. The modification layer is an inorganic coating consisting of a first particle layer and a second particle layer; the first particle layer and the second particle layer are respectively formed by first particles and second particles, and the first particle and the second particle have different particle sizes; the first particle layer is formed by laying or densely stacking the first particles, and the second particle layer is formed by embedding the second particles in gaps of the first particle layer; the first particles are inorganic particles; the second particles are natural organic particles; and the first particles and the second particles meet an expression of: (2\sqrt{3}/3−1)<(r′/r)<(\sqrt{6}/2−1), where r represents a radius of the first particles, r′ represents a radius of the second particles.

In a second aspect, the disclosure provides a method for preparing a separator for a lithium ion battery, including:

S1, preparing a substrate, and roughening the substrate;

S2, dispersing 100 parts by volume of first particles with a radius of r and 0.01-0.9 wt % polyvinyl alcohol in water, and ball milling for 3-20 minutes to form a first particle paste; and dispersing 2-5 parts by volume of second particles with a radius of r′ and 0.01-0.9 wt % polyvinyl alcohol in water, and ultrasonically dispersing for 3-20 minutes to form a second particle paste;

S3, spraying the first particle paste on a side of the roughened substrate at a first spray pressure to form a first particle layer, and embedding the second particles in gaps of the first particle layer by spraying an equal volume of the second particle paste at a second spray pressure to form a second particle layer;

S4, drying the substrate, the first particle layer, and the second particle layer; and

S5, compressing the first particle layer and the second particle layer, thereby forming the separator.

In a third aspect, the disclosure provides a lithium ion battery, the lithium ion battery includes the separator as described in the first aspect.

### BRIEF DESCRIPTION OF THE DRAWINGS

FIG. 1 is a schematic diagram showing the position and size of the second particles when the first particles are laid.

FIG. 2 is a schematic diagram showing the position and size of the second particles when the first particles are densely stacked.

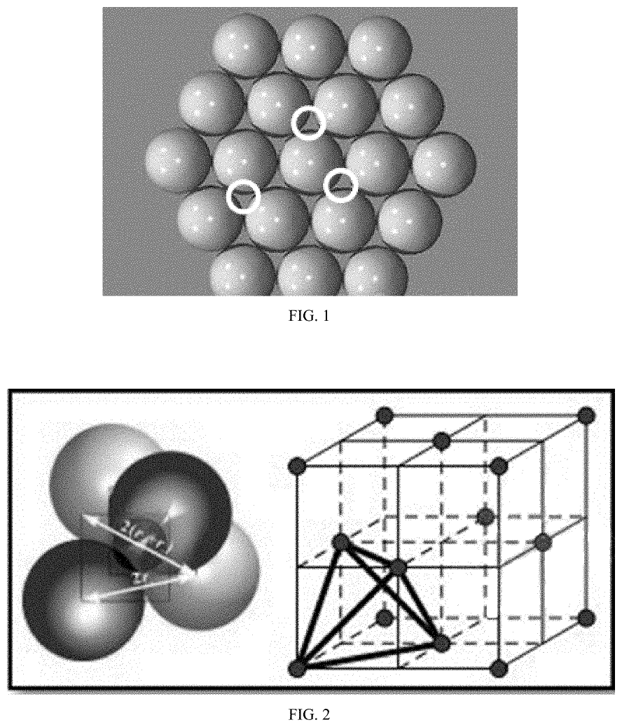

### DETAILED DESCRIPTION OF PREFERRED EMBODIMENTS

The technical problem to be solved by the disclosure is to provide a separator for a lithium ion battery, in particular to provide a high-performance lithium ion battery separator modified with inorganic particles, and the application and preparation method thereof, so as to solve the problems of insufficient stability and high temperature resistance of the separator for the lithium ion battery in the prior art, as well as the problem of membrane pore blockage caused by the addition of binder.

In an embodiment, the disclosure provides a separator for a lithium ion battery. The separator includes a substrate and a modification layer coated on the surface of the substrate, the substrate is a porous material selected from one or more of the group consisting of polyethylene, polypropylene, aramid, polyimide, polyethylene terephthalate, cellulose, and composite film.

Optionally, the thickness of the substrate is 5-50 μm, preferably 20-40 μm.

Optionally, the modification layer is an inorganic coating consisting of a first particle layer and a second particle layer.

Optionally, the first particle and the second particle have different particle sizes.

Optionally, the first particles are inorganic particles with a first size, and a particle size of the first particle with the first size is represented by a radius r.

Optionally, r is 20-100 nm.

Optionally, the first particle is selected from one or more of the group consisting of boehmite, aluminum oxide, titanium oxide, calcium oxide, zinc oxide, copper oxide, and manganese oxide.

Optionally, the second particles are natural organic particles with a second size, and a particle size of the second particle with the second size is represented by a radius r′; preferably, r and r′ meet a relationship of: (2\sqrt{3}/3−1)<(r′/r)<(\sqrt{6}/2−1).

It should be noted that the radius r may be a statistical average of the radii of the first particles; the radius r′ may be a statistical average of the radii of the second particles.

Optionally, in the modification layer, a ratio of the volume of the second particles to the volume of the first particles is 2-5:100.

Optionally, the second particles are made of natural organic shells, preferably eggshells, seashell, or abaloneshell.

Optionally, the natural organic shells are egg shells, duck eggshells, goose eggshells, or other bird/amphibian eggshells.

Optionally, the second particles are made by crushing, ball milling and grinding the natural organic shells to a corresponding size r′.

Optionally, the first particles and/or the second particles are modified by dipping, spraying, and/or coating when they are crushed and ball milled to a specified diameter range.

Optionally, the first particle layer is formed by laying the first particles, and the second particle layer is formed by embedding the second particles in interspaces of the laid or densely stacked first particles, and the radii meet the relationship of: (2\sqrt{3}/3−1)<(r′/r).

Optionally, the first particle layer is formed by densely stacking the first particles, and the radius of the second particles meets the relationship of: (r′/r)<(\sqrt{6}/2−1).

Optionally, the first particles and the second particles are coated on both sides of the substrate.

In an embodiment, the disclosure provides an application of the above-mentioned separator for the lithium ion battery.

In an embodiment, the disclosure provides a lithium ion battery. The lithium-ion battery includes a separator for the lithium ion battery, the lithium-ion battery separator includes a substrate and a coating attached to the surface of the substrate, the substrate is a porous material selected from one or more of the group consisting of polyethylene, polypropylene, aramid, polyimide, polyethylene terephthalate, cellulose, and composite film.

Optionally, the thickness of the substrate is 5-50 μm.

Optionally, the coating is an inorganic coating consisting of first particles and second particles.

Optionally, the first particle and the second particle have different particle sizes.

Optionally, the first particles are inorganic particles with a first size, and a particle size of the first particle with the first size is represented by a radius r.

Optionally, r is 20-100 nm.

Optionally, the first particle is selected from one or more of the group consisting of boehmite, aluminum oxide, titanium oxide, calcium oxide, zinc oxide, copper oxide, and manganese oxide.

Optionally, the second particles are natural organic particles with a second size, and a particle size of the second particle with the second size is represented by a radius r′; preferably, r and r′ meet a relationship of: (2\sqrt{3}/3−1)<(r′/r)<(\sqrt{6}/2−1).

It should be noted that the radius r may be a statistical average of the radii of the first particles; the radius r′ may be a statistical average of the radii of the second particles.

Optionally, a ratio of the volume of the second particles to the volume of the first particles is 2-5:100.

Optionally, the second particles are made of natural organic shells, preferably eggshells, seashell, or abaloneshell.

Optionally, the natural organic shells are egg shells, duck eggshells, goose eggshells, or other bird/amphibian eggshells.

Optionally, the second particles are made by crushing, ball milling and grinding the natural organic shells to a corresponding size r′.

Optionally, the first particle layer is formed by laying or densely stacking the first particles, and the second particle layer is formed by embedding the second particles in interspaces of the laid or densely stacked first particles, and the radii meet the relationship of: (2\sqrt{3}/3−1)<(r′/r).

Optionally, when the first particles are densely stacked, and the radius of the second particles meets the relationship of: (r′/r)<(\sqrt{6}/2−1). Preferably, the first particles and the second particles are coated on both sides of the substrate.

In an embodiment, the disclosure provides a method for preparing a separator for a lithium ion battery.

Specifically, a method for preparing an inorganic high-performance lithium ion battery separator, including the following steps:

S1, preparing a substrate material, and roughening the substrate material.

S2, preparing pastes, including dispersing 100 parts (volume fraction) of first particles with a radius of r and 0.01-0.9 wt % polyvinyl alcohol (alcoholysis degree: 97-99 mol %, viscosity: 25-30 mPa·s) in water, and ball milling for 3-20 minutes to form a first particle paste; and dispersing 2-5 parts of second particles with a radius of r′ (r′ meets the relationship of: (2\sqrt{3}/3−1)<(r′/r)<(\sqrt{6}/2−1) and 0.01-0.9 wt % polyvinyl alcohol (alcoholysis degree: 97-99 mol %, viscosity: 25-30 mPa·s) in water, and ultrasonically dispersing for 3-20 minutes to form a second particle paste.

S3, spraying the first particle paste on both sides of the roughened substrate at a first spray pressure to form the first particle layers, and embedding the second particles in gaps of respective first particle layers by spraying an equal volume of the second particle paste at a second spray pressure to form the second particle layers.

S4, drying the substrate, the first particle layers, and the second particle layers.

S5, compressing the first particle layers and the second particle layers.

It should be noted that the radius r may be a statistical average of the radii of the first particles; the radius r′ may be a statistical average of the radii of the second particles.

Optionally, the thickness of the substrate is 5-50 μm.

Optionally, in the first particle layer, the first particle is selected from one or more of the group consisting of boehmite, aluminum oxide, titanium oxide, calcium oxide, zinc oxide, copper oxide, and manganese oxide.

Optionally, in the second particle layer, the second particles are eggshells, seashells, or abaloneshells; preferably egg shells, duck eggshells, goose eggshells, or other bird/amphibian eggshells;

Optionally, a particle size of the first particle with a first size is represented by the radius r, and r is about 20-100 nm;

Optionally, the second particles are natural organic particles with a second size, and a particle size of the second particle with the second size is represented by the radius r′, preferably r′ meets the relationship of:

(2\sqrt{3}/3−1)<(r′/r)<(\sqrt{6}/2−1).

Optionally, a ratio of the volume of the second particles to the volume of the first particles is 2-5:100; the second spray pressure is 1.2-2.0 times of the first spray pressure.

Optionally, the substrate material is roughened by brushing, washing, derivatization, or the like.

Optionally, the first particle layers and the second particle layers are compressed by a pressing roller.

Optionally, the first particles and the second particles may be sprayed and coated at one time through a two-component nozzle.

Beneficial effects: in the solution, the first particle layer and the second particle layer are combined to form an integrated separator material for a lithium ion battery. The inorganic material does not fall off. Compared with the traditional inorganic modified separator for the lithium ion battery, the solution has the technical effects of higher stability and high temperature resistance, and solves the technical problem that, in the prior art, the inorganic particles are relatively large and need to use more binders, and the problem that large gaps among inorganic particles affect the performance of lithium ion battery. By adopting less or no binder, it is not easy to block the gaps of the separator, the separator has high ion mobility, ion conductivity, chemical stability, and thermal stability, and it is easy to obtain a separator material with an appropriate thickness.

### Example 1

Preparation of the Separator

S1, preparing a polypropylene substrate material with a thickness of 20 μm, and roughening the substrate material with a brush.

S2, preparing the first particles and the second particles used for pastes, by selecting boehmite as first particles with a radius of r (r=50 nm), and selecting egg shell powder as second particles with a radius of r′ (r′=10 nm); dispersing 98 parts of boehmite and 0.2 wt % polyvinyl alcohol (alcoholysis degree: 99 mol %, viscosity: 29 mPa·s) in water, and ball milling for 5 minutes to form a first particle paste for later use; and dispersing 2 parts of egg shell powder and 0.8 wt % polyvinyl alcohol (alcoholysis degree: 99 mol %, viscosity: 29 mPa·s) in water, and ultrasonically dispersing for 5 minutes to form a second particle paste for later use.

S3, spraying the first particle paste on both sides of the substrate to form first particle layers, and embedding the second particles in gaps of respective first particle layers by spraying the second particle paste to form second particle layers.

S4, drying the substrate, the first particle layers, and the second particle layers.

S5, compressing the first particle layers and the second particle layers, a rubber pressing roller being used to compress the first particle layers and the second particle layers at a pressure of 0.3 MPa.

The prepared separator material is a sample S1.

### Example 2

Preparation of the Separator

S1, preparing a polypropylene substrate material with a thickness of 40 μm, and roughening the substrate material with a brush.

S2, modifying the first particles, including: selecting boehmite as first particles with a radius of r (r=50 nm), and selecting seashell powder as second particles with a radius of r′ (r′=10 nm); dispersing 98 parts of boehmite and 0.2 wt % polyvinyl alcohol (alcoholysis degree: 99 mol %, viscosity: 28 mPa·s) in water, and ball milling for 5 minutes to form a first particle paste for later use; dispersing 2 parts of seashell powder and 0.8 wt % polyvinyl alcohol (alcoholysis degree: 99 mol %, viscosity: 29 mPa·s) in water, and ultrasonically dispersing for 5 minutes to form a second particle paste for later use.

S3, spraying the first particle paste on both sides of the substrate to form first particle layers, and embedding the second particles in gaps of respective first particle layers by spraying the second particle paste to form second particle layers.

S4, drying the substrate, the first particle layers, and the second particle layers.

S5, compressing the first particle layers and the second particle layers, a rubber pressing roller being used to compress the first particle layers and the second particle layers at a pressure of 0.3 MPa.

The prepared separator material is a sample S2.

### Example 3

Preparation of the Separator

S1, preparing a polypropylene substrate material with a thickness of 40 μm, and roughening the substrate material with a brush.

S2, modifying the first particles, including: selecting boehmite as first particles with a radius of r (r=50 nm), and selecting polyethylene glycol particle as second particles with a radius of r′ (r′=10 nm); dispersing 98 parts of boehmite and 0.2 wt % polyvinyl alcohol (alcoholysis degree: 99 mol %, viscosity: 28 mPa·s) in water, and ball milling for 5 minutes to form a first particle paste for later use; dispersing 2 parts of polyethylene glycol particle and 0.8 wt % polyvinyl alcohol (alcoholysis degree: 99 mol %, viscosity: 29 mPa·s) in water, and ultrasonically dispersing for 5 minutes to form a second particle paste for later use.

S3, spraying the first particle paste on both sides of the substrate to form first particle layers, and embedding the second particles in gaps of respective first particle layers by spraying the second particle paste to form second particle layers.

S4, drying the substrate, the first particle layers, and the second particle layers.

S5, compressing the first particle layers and the second particle layers, a rubber pressing roller being used to compress the first particle layers and the second particle layers at a pressure of 0.3 MPa.

The prepared separator material is a sample S3.

### Example 4

Preparation of the Separator

S1, preparing a polypropylene substrate material with a thickness of 40 μm, and roughening the substrate material with a brush.

S2, modifying the first particles, including: selecting boehmite as first particles with a radius of r (r=100 nm), and selecting egg shell powder as second particles with a radius of r′ (r′=10 nm); dispersing 98 parts of boehmite and 0.2 wt % polyvinyl alcohol (alcoholysis degree: 99 mol %, viscosity: 29 mPa·s) in water, and ball milling for 5 minutes to form a first particle paste for later use; and dispersing 2 parts of egg shell powder and 0.8 wt % polyvinyl alcohol (alcoholysis degree: 99 mol %, viscosity: 29 mPa·s) in water, and ultrasonically dispersing for 5 minutes to form a second particle paste for later use.

S3, spraying the first particle paste on both sides of the substrate to form first particle layers, and embedding the second particles in gaps of respective first particle layers by spraying the second particle paste to form second particle layers.

S4, drying the substrate, the first particle layers, and the second particle layers.

S5, compressing the first particle layers and the second particle layers, a rubber pressing roller being used to compress the first particle layers and the second particle layers at a pressure of 0.3 MPa.

The prepared separator material is a sample S4.

### Example 5

Preparation of the Separator

S1, preparing a polypropylene substrate material with a thickness of 40 μm, and roughening the substrate material with a brush.

S2, modifying the first particles, including: selecting boehmite as first particles with a radius of r (r=100 nm), and selecting egg shell powder as second particles with a radius of r′ (r′=50 nm); dispersing 98 parts of boehmite and 0.2 wt % polyvinyl alcohol (alcoholysis degree: 99 mol %, viscosity: 29 mPa·s) in water, and ball milling for 5 minutes to form a first particle paste for later use; and dispersing 2 parts of egg shell powder and 0.8 wt % polyvinyl alcohol (alcoholysis degree: 99 mol %, viscosity: 29 mPa·s) in water, and ultrasonically dispersing for 5 minutes to form a second particle paste for later use.

S3, spraying the first particle paste on both sides of the substrate to form first particle layers, and embedding the second particles in gaps of respective first particle layers by spraying the second particle paste to form second particle layers.

S4, drying the substrate, the first particle layers, and the second particle layers.

S5, compressing the first particle layers and the second particle layers, a rubber pressing roller being used to compress the first particle layers and the second particle layers at a pressure of 0.3 MPa.

The prepared separator material is a sample S5.

### Example 6

Preparation of the Separator

S1, preparing a polypropylene substrate material with a thickness of 40 μm, and roughening the substrate material with a brush.

S2, modifying the first particles, including: selecting boehmite as first particles with a radius of r (r=100 nm), and selecting egg shell powder as second particles with a radius of r′ (r′=20 nm); dispersing 98 parts of boehmite and 0.2 wt % polyvinyl alcohol (alcoholysis degree: 99 mol %, viscosity: 29 mPa·s) in water, and ball milling for 5 minutes to form a first particle paste for later use; and dispersing 2 parts of egg shell powder and 0.8 wt % polyvinyl alcohol (alcoholysis degree: 99 mol %, viscosity: 29 mPa·s) in water, and ultrasonically dispersing for 5 minutes to form a second particle paste for later use.

S3, spraying the first particle paste on both sides of the substrate to form first particle layers, and embedding the second particles in gaps of respective first particle layers by spraying the second particle paste to form second particle layers.

S4, drying the substrate, the first particle layers, and the second particle layers.

S5, compressing the first particle layers and the second particle layers, a rubber pressing roller being used to compress the first particle layers and the second particle layers at a pressure of 0.3 MPa.

The prepared separator material is a sample S6.

TABLE 1
Properties of separators in Examples 1 to 6

| | thickness | air | | | shrinkage | | | | |
|---|---|---|---|---|---|---|---|---|---|
| | of the | perme- | areal | peel | rate (%) | surface | liquid | liquid | breakdown |
| | coating | ability | density | strength | (150° C. | resistance | absorbency | retentivity | voltage |
| sample | (um) | (s/100 mL) | (g/m²) | (N/m) | 1 h) | (Ω/cm²) | (g/m²) | (g/m²) | (kV) |
| polypro- | — | 170 | 4.1 | — | 90 | 1.12 | 3.2 | 3.1 | 1.2 |
| pylene | | | | | | | | | |
| substrate | | | | | | | | | |
| layer | | | | | | | | | |
| S1 | 360 | 280 | 4.5 | 108 | 4 | 1.20 | 5.0 | 4.8 | 1.8 |
| S2 | 400 | 290 | 5.2 | 90 | 5 | 1.29 | 4.8 | 3.9 | 1.5 |
| S3 | 370 | 190 | 4.3 | 110 | 50 | 1.31 | 3.5 | 3.8 | 1.3 |
| S4 | 600 | 120 | 5 | 102 | 4 | 1.55 | 3.7 | 3.9 | 1.6 |
| S5 | 760 | 330 | 5.5 | 70 | 7 | 1.25 | 4.5 | 4.2 | 1.5 |
| S6 | 640 | 270 | 5.3 | 100 | 5 | 1.22 | 4.9 | 5.1 | 1.9 |

The above description is only the preferred embodiments of the application and are not intended to limit the application. Any modification, equivalent replacement, and improvement made within the spirit and principle of the disclosure shall be included in the protection scope of the application.

What is claimed is:

1. A separator for a lithium ion battery, comprising a substrate and a modification layer, the substrate being a porous material selected from one or more of the group consisting of polyethylene, polypropylene, aramid, polyimide, polyethylene terephthalate, and cellulose, wherein
the modification layer is an inorganic coating consisting of a first particle layer and a second particle layer;
the first particle layer and the second particle layer are respectively formed by first particles and second particles, and the first particle and the second particle have different particle sizes;
the first particle layer is formed by laying or densely stacking the first particles, and the second particle layer is formed by embedding the second particles in gaps of the first particle layer; and
the first particles are inorganic particles; the second particles are natural organic particles; and the first particles and the second particles meet an expression of:
(2\sqrt{3}/3−1)<(r′/r)<(\sqrt{6}/2−1)
where r represents a radius of the first particles, r′ represents a radius of the second particles.

2. The separator as claimed in claim 1, wherein the first particle is selected from one or more of the group consisting of boehmite, aluminum oxide, titanium oxide, calcium oxide, zinc oxide, copper oxide, and manganese oxide.

3. The separator as claimed in claim 1, wherein r is 20-100 nm.

4. The separator as claimed in claim 1, wherein the second particles are made of natural organic shells, and the natural organic shells are selected from eggshells and seashells.

5. The separator as claimed in claim 4, wherein the natural organic shells are bird eggshells or reptile eggshells.

6. The separator as claimed in claim 1, wherein in the modification layer, a ratio of the volume of the second particles to the volume of the first particles is 2:100 to 5:100.

7. The separator as claimed in claim 1, wherein the second particles are made by grinding natural organic shells to the size r′.

8. The separator as claimed in claim 1, wherein a thickness of the substrate is 5-50 μm.

9. The separator as claimed in claim 1, wherein the first particles and the second particles are coated on one or two sides of the substrate.

10. A method for preparing a separator for a lithium ion battery, comprising:
S1, preparing a substrate, and roughening the substrate;
S2, dispersing 100 parts by volume of first particles with a radius of r and 0.01-0.9 wt % polyvinyl alcohol in water, and ball milling for 3-20 minutes to form a first particle paste; and dispersing 2-5 parts by volume of second particles with a radius of r′ and 0.01-0.9 wt % polyvinyl alcohol in water, and ultrasonically dispersing for 3-20 minutes to form a second particle paste;
S3, spraying the first particle paste on a side of the roughened substrate at a first spray pressure to form a first particle layer, and embedding the second particles in gaps of the first particle layer by spraying an equal volume of the second particle paste at a second spray pressure to form a second particle layer;
S4, drying the substrate, the first particle layer, and the second particle layer; and
S5, compressing the first particle layer and the second particle layer, thereby forming the separator.

11. The method as claimed in claim 10, wherein the polyvinyl alcohol has an alcoholysis degree of 97-99 mol %, and a viscosity of 25-30 mPa·s.

12. The method as claimed in claim 10, wherein r is 20-100 nm.

13. The method as claimed in claim 12, wherein r and r′ meet an expression of: (2\sqrt{3}/3−1)<(r′/r)<(\sqrt{6}/2−1).

14. The method as claimed in claim 10, wherein a thickness of the substrate is 5-50 μm, and the substrate is a porous material selected from one or more of the group consisting of polyethylene, polypropylene, aramid, polyimide, polyethylene terephthalate, and cellulose.

15. The method as claimed in claim 10, wherein the first particle is selected from one or more of the group consisting of boehmite, aluminum oxide, titanium oxide, calcium oxide, zinc oxide, copper oxide, and manganese oxide.

16. The method as claimed in claim 10, wherein the second particles are made of natural organic shells, and the natural organic shells are selected from eggshells and seashells.

17. The method as claimed in claim 10, wherein a ratio of the volume of the second particles to the volume of the first particles is 2:100 to 5:100.

18. The method as claimed in claim 10, wherein before S2, the method further comprises:
modifying the first particles and/or the second particles by dipping, spraying, and/or coating.

19. The method as claimed in claim 10, wherein the second spray pressure is 1.2-2.0 times of the first spray pressure.

20. A lithium ion battery, comprising a separator, wherein the separator comprises a substrate and a modification layer, and the substrate is a porous material selected from one or more of the group consisting of polyethylene, polypropylene, aramid, polyimide, polyethylene terephthalate, and cellulose, wherein
the modification layer is an inorganic coating consisting of a first particle layer and a second particle layer;
the first particle layer and the second particle layer are respectively formed by first particles and second particles, and the first particle and the second particle have different particle sizes;
the first particle layer is formed by laying or densely stacking the first particles, and the second particle layer is formed by embedding the second particles in gaps of the first particle layer; and
the first particles are inorganic particles; the second particles are natural organic particles; and the first particles and the second particles meet an expression of:
(2\sqrt{3}/3−1)<(r′/r)<(\sqrt{6}/2−1)
where r represents a radius of the first particles, r′ represents a radius of the second particles.
